(19) United States
(12) Patent Application Publication
(10) Pub. No.: US 2023/0419854 A1
(43) Pub. Date: Dec. 28, 2023

(54) METHOD AND DEVICE FOR PROVIDING REUSABLE LEARNING AIDS TO USERS

(71) Applicant: TOSHIBA TEC KABUSHIKI KAISHA, Tokyo (JP)

(72) Inventor: Kokrady VANISHREE, Bangalore (IN)

(73) Assignee: TOSHIBA TEC KABUSHIKI KAISHA, Tokyo (JP)

(21) Appl. No.: 18/082,420

(22) Filed: Dec. 15, 2022

(30) Foreign Application Priority Data
May 17, 2022 (IN) 202241028182

(51) Int. Cl. G09B 19/00; H04N 1/00; G06K 19/06

(52) U.S. Cl. CPC G09B 19/00; H04N 2201/0094; G06K 19/06037; H04N 1/00204

(57) ABSTRACT

A method and device for providing reusable learning aids to users is described. The method comprises printing, by a Multi-Function Printer, MFP, (103), the learning aids (209) on a plurality of papers using an erasable ink, wherein each of the plurality of papers comprise a unique identifier corresponding to the users (101) of the learning aids (209). Further, the method comprises scanning each of the plurality of papers comprising one or more user inputs (211) and storing scanned content (213) in a Document Management System, DMS, (105) associated with the MFP (103), wherein the one or more user inputs (211) are provided on the plurality of papers by the users (101), using an erasable ink material. Finally, the method comprises erasing the erasable ink on each of the plurality of papers upon storing the scanned content (213) in the DMS (105) for reusing the plurality of papers.

### TECHNICAL FIELD

The present subject matter is, in general, related to use of erasable printers as a learning tool and more particularly, but not exclusively, to a method and device for providing reusable learning aids to users.

### BACKGROUND

In general, the education system includes everything that is required to educate a student at a public level. The education system provides various teaching resources or learning aids to the students, which can be used by the students for their academic studies. The learning aids are designed to enhance learning and retention of the students.

Presently, educational institutions provide various learning aids to the students. These learning aids may include traditional tools such as textbooks and notebooks or new-age learning tools such as smart devices and e-gadgets. The traditional learning tools have a large ecological footprint as the textbooks and notebooks have to be printed newly on every academic year, which are subsequently discarded after the learning period. On the other hand, the e-gadgets have ecological footprint of their manufacturing and disposal. Further, the e-gadgets have a maintained cycle, so when handled by young students, they end up having a short lifecycle, thereby resulting in generation of large quantity of e-waste as the gadgets need to be replaced regularly. Also, the new-age tools like e-gadgets do not provide the sensory feedback of touch and feel to the students, which is required for overall cognitive development of the students. Hence, there is a need for providing reusable learning aids to the students that overcomes the drawback in both the traditional and the new-age learning aids.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method for providing reusable learning aids to users. The method comprises printing, by a Multi-Function Printer (MFP), the learning aids on a plurality of papers using an erasable ink, wherein each of the plurality of papers comprise a unique identifier corresponding to the users of the learning aids. Further, the method comprises scanning each of the plurality of papers comprising one or more user inputs and storing scanned content in a Document Management System (DMS) associated with the MFP, wherein the one or more user inputs are provided on the plurality of papers by the users, using an erasable ink material. Finally, the method comprises erasing the erasable ink on each of the plurality of papers upon storing the scanned content in the DMS for reusing the plurality of papers.

Further, the present disclosure relates to a Multi-Function Printer (MFP) for providing reusable learning aids to users. The MFP comprises a processor and a memory. The memory is communicatively coupled to the processor and stores processor-executable instructions, which on execution, cause the processor to print the learning aids on a plurality of papers using an erasable ink, wherein each of the plurality of papers comprise a unique identifier corresponding to the user of the learning aids. Further, the instructions cause the processor to scan each of the plurality of papers comprising one or more user inputs and store scanned content in a Document Management System (DMS) associated with the MFP, wherein the one or more user inputs are provided on the plurality of papers by the users, using an erasable ink material. Finally, the instructions cause the processor to erase the erasable ink on each of the plurality of papers upon storing the scanned content in the DMS for reusing the plurality of papers.

Furthermore, the present disclosure relates to a non-transitory computer readable medium including instructions stored thereon that when processed by at least one processor, cause a Multi-Function Printer, MFP, to perform operations comprising: printing the learning aids on a plurality of papers using an erasable ink, wherein each of the plurality of papers comprise a unique identifier corresponding to the users of the learning aids; scanning each of the plurality of papers comprising one or more user inputs and storing scanned content in a Document Management System, DMS, associated with the MFP, wherein the one or more user inputs are provided on the plurality of papers by the users, using an erasable ink material; and erasing the erasable ink on each of the plurality of papers upon storing the scanned content in the DMS for reusing the plurality of papers.

In at least one embodiment of the present disclosure, the unique identifier comprises at least one of a Quick Response (QR) code or a watermark for uniquely identifying the users.

In a further at least one of the present disclosure, the one or more user inputs comprise handwritten content of the one or more users.

In a further at least one embodiment of the present disclosure, the erasable ink material is a heat erasable ink pen.

In a further at least one embodiment of the present disclosure, the method comprises comparing the scanned content with prestored learning aids, separating the user inputs from the scanned content based on the comparison, and storing the user inputs in a DMS profile associated with the unique identifier of the users.

In a further at least one embodiment of the present disclosure, the method comprises facilitating the users to access the scanned content stored in the DMS upon authentication of the users.

In a further at least one embodiment of the present disclosure, the method comprises embossing the learning aids with the one or more user inputs for allowing the users to refer the respective one or more user inputs previously provided by the users.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 illustrates an exemplary environment of providing reusable learning aids to users in accordance with at least one embodiment of the present disclosure.

FIG. 2 shows a detailed block diagram illustrating a Multi-Function Printer (MFP) in accordance with at least one embodiment of the present disclosure.

FIG. 3 shows a flowchart illustrating a method for providing reusable learning aids to users in accordance with at least one embodiment of the present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

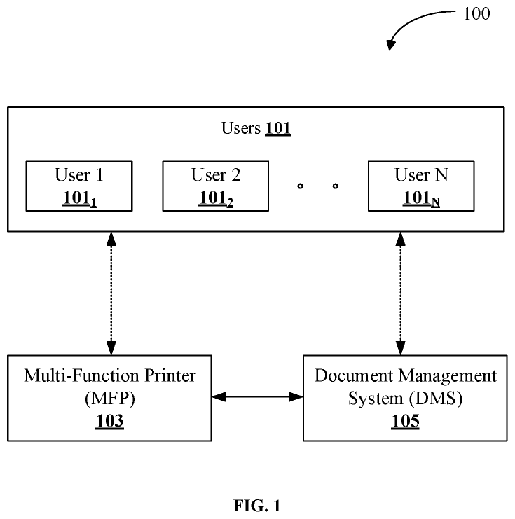

FIG. 1 illustrates an exemplary environment for providing reusable learning aids to users in accordance with some embodiments of the present disclosure.

In an embodiment, the environment 100 may comprise, without limiting to, one or more users 101, a Multi-Function Printer (MFP) 103 and a Document Management System (DMS) 105. In an implementation, the one or more users 101 may include, without limiting to, students, teachers, parents and/or a guardian of the students. The MFP 103 may be an electronic device which is configured with a consolidated functionality of a printer, a scanner, a copier and/or a fax machine. In an implementation, the DMS 105 may include, without limiting to, a cloud server or a virtual server that is configured to store learning aids and other data required and used by the users 101.

In at least one embodiment, the MFP 103 may print the learning aids 209 on a plurality of papers using an erasable ink and provide to the one or more users 101. Each of the plurality of papers comprise a unique identifier or code corresponding to the one or more users 101 of the learning aids 209. As an example, the unique identifier comprises at least one of a Quick Response (QR) code or a watermark for uniquely identifying the one or more users 101.

In at least one embodiment, the one or more users 101 provide one or more user inputs on a plurality of papers using an erasable ink material. As an example, the one or more user inputs may be the notes taken down by the one or more users during a class/learning session. The one or more user inputs may be handwritten content. Further, the erasable ink material may include, without limiting to, a heat erasable ink pen. In an embodiment, the one or more user inputs may be collected from the one or more users and submitted to the MFP 103.

In at least one embodiment, the MFP 103 may scan each of the plurality of papers comprising the one or more user inputs and store the scanned content in the DMS 105. As an example, the scanned content may comprise a combination of pre-printed learning aids (topics, questionnaire etc. provided to the users by a teacher) and the one or more user inputs (notes, answers etc. written by the one or more users 101).

In at least one embodiment, at the DMS 105, the scanned content may be compared with the pre-stored learning aids to identify and separate the newly received user inputs from the already printed content. Subsequently, the separated one or more user inputs are stored in a DMS profile of the one or more users 101. That is, the user input received from the user 1 101₁ is associated with a unique identifier of the user 101₁. In an embodiment, while storing the separated content, the one or more user inputs may be embossed alongside the pre-printed learning aids to allow the users to refer both the user inputs and the learning aids simultaneously.

In at least one embodiment, after successfully scanning and storing the one or more user inputs on the DMS 105, the MFP 103 may erase or decolor the erasable ink on each of the plurality of papers, thereby allowing the one or more users to reuse the same papers in subsequent classes and/or learning sessions. Thus, the MFP 103 ensures that the one or more users get the advantage of traditional learning aids (i.e., improving writing skills and giving the touch and feel of the writing material) as well as the benefits of new-age learning aids (i.e., reducing carbon footprint and amount of e-waste generated.

In at least one embodiment, the one or more users 101 may be given an access to the scanned content stored in the DMS at any time, through any electronic device, after completing an authentication procedure. In an implementation, the one or more users 101 may authenticate themselves with the DMS 105 by verifying a preset password associated with the DMS profile of the one or more users 101. As an example, the electronic device may include, without limitation, a smartphone, a tablet, a laptop and/or a desktop computer.

In at least one embodiment, the proposed method and the set-up 101 may not be limited to use in educational instructions or as learning aids. Instead, the proposed method and the set-up 101 may be implemented for any other use case that involves printing, scanning and storing any piece of data/information. For example, the proposed method may be implemented in Hospitals, wherein the prescriptions written by the Doctors may be scanned and digitally stored against a particular patient record and during subsequent follow-up visits, the Doctors may re-use the same prescription sheet for recommending further course of medication to the patient.

In at least one embodiment, the MFP 103 may be configured to select and print a content based on specific user, date and time of print or based on progress of the user in using the learning aid. This may be driven by a pre-programmed method and/or based on monitoring and inputs by a teacher. That is, the MFP 103 may be configured to automatically display the content to be printed for the user once the user has logged into his/her profile, thereby ensuring that the user need not manually search for the content to be printed.

In at least one embodiment, the DMS 105 may function as a closed loop system that has internal records of all the learning aids that the user has printed and is currently in possession. Thus, the DMS 105, through the MFP 103, can present a list of the learning aids that the user is required to present/submit for scanning and storing in the DMS 105. In other words, the MFP 103 may display a notification/warning to the users 101 in case the printed learning aid is not scanned back and stored to the DMS 105 at the end of the learning session.

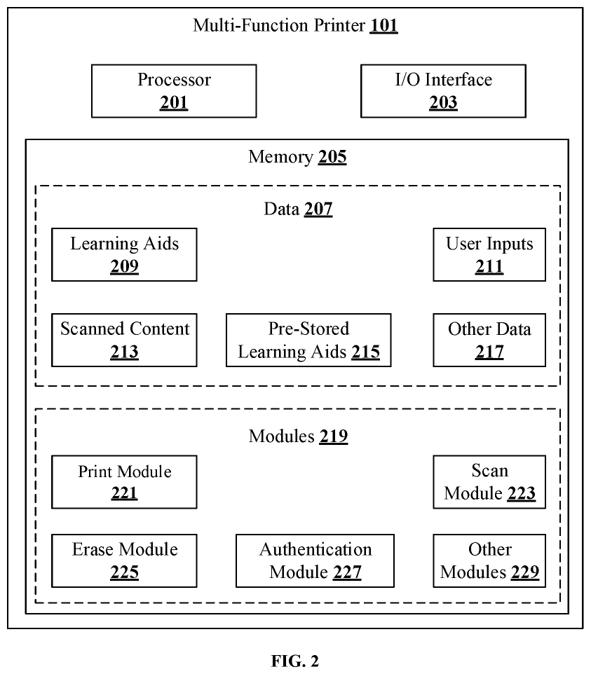

FIG. 2 shows a detailed block diagram illustrating a Multi-Function Printer (MFP) in accordance with at least one embodiment of the present disclosure.

In some implementations, the MFP 103 may include a processor 201, an I/O interface 203 and a memory 205. The memory 205 may be communicatively coupled to the processor 201 and may include one or more modules 207 and data 207. The I/O interface 203 may be used to receive one or more user inputs 211 from the one or more users 101. The processor 201 may be configured to perform one or more functions of the MFP 103 for providing reusable learning aids to the users.

In at least one embodiment, the data 207 may include, without limitation, learning aids 209, one or more user inputs 211, scanned content 213, pre-stored learning aids 215 and other data 217. In an embodiment, the learning aids 209 may include, without limiting to, study materials which can be printed on the plurality of papers for providing to the one or more users 101. In an embodiment, the one or more user inputs 211 may comprise, without limiting to, the handwritten content provided by the one or more users 101 using the erasable ink material. In an embodiment, the scanned content 213 may comprise one or more user inputs 211 along with the already printed learning aids 215. In an embodiment, the pre-stored learning aids 215 may include the content materials which are previously stored in the DMS. The other data 217 may store various temporary data and files generated by the one or modules while performing various function of the MFP 103.

In at least one embodiment, the data 207 may be processed by the one or more modules 219. In some implementation, the one or more modules 219 may be communicatively coupled to the processor 201 for performing one or more functions of the MFP 103. In an implementation, the one or more modules 219 may include, without limiting to, a print module 221, a scan module 223, an erase module 225, an authentication module 227 and other modules 229.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. In an embodiment, the other modules 229 may be used to perform various miscellaneous functionalities of the MFP 103. It will be appreciated that such one or more modules 219 may be represented as a single module or a combination of different modules.

In at least one embodiment, the print module 221 may be configured to print the learning aids 209 on a plurality of papers using an erasable ink. In an implementation, the plurality of papers comprises a unique identifier corresponding to the users 101 of the learning aids 209. The unique identifier helps to identify the one or more papers belonging to the one or more users 101. In an implementation, the unique identifier comprises at least one of a QR code or a watermark that helps in uniquely identifying the one or more users 101.

In at least one embodiment, the scan module 223 may be configured to scan each of the plurality of papers comprising one or more user inputs 211 provided by one or more users 101. Subsequently, the scanned content is stored in the DMS 105. In an implementation, the erasable ink material may include, without limiting to, the heat erasable ink pen. In an implementation, both the scanned content 213, comprising the one or more user inputs 211, and the printed learning aids 209 are stored in the DMS 105. In an embodiment, the scan module 211 may be also configured to compare the scanned content 213 with pre-stored learning aids 215 to separate the one or more user inputs 211 from the scanned content 213 which is already printed on the papers. Subsequently, the scan module 223 may emboss the learning aids 219 with the one or more user inputs 211 for allowing the users to refer the respective one or more user inputs 211 at any time after the class/learning session.

In at least one embodiment, the erase module 225 may be configured to erase the erasable ink on each of the plurality of papers after scanning and storing the scanned content 213 in the DMS 105. The erased papers are reused for printing fresh learning aids and then subsequently receive fresh user inputs from the users 101.

In at least one embodiment, the authentication module 227 may be configured for authenticating the one or more users 101 when the one or more users 101 request an access to the learning aids and/or user inputs stored in the DMS 105. The authentication module 227 authenticates the one or more users 101 by verifying a secret password and/or biometric details of the one or more users 101.

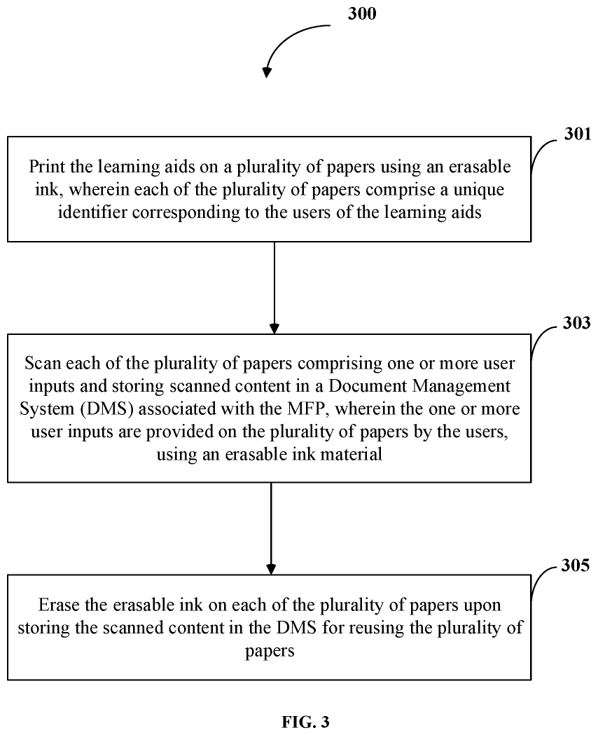

FIG. 3 shows a flowchart illustrating a method for providing reusable learning aids to users in accordance with at least one embodiment of the present disclosure.

As illustrated in FIG. 3, the method 300 may include one or more blocks illustrating a method for providing reusable learning aids 209 using a Multi-Function Printer (MFP) 103 illustrated in FIG. 1. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof

At block 301, the method includes printing, by the MFP 103, the learning aids 209 on a plurality of papers using an erasable ink, wherein each of the plurality of papers comprise a unique identifier corresponding to the users 101 of the learning aids 209. In an implementation, the unique identifier comprises at least one of the QR code or the watermark for uniquely identifying the one or more users 101. In an embodiment, the learning aids 209 may include, without limiting to, study materials which can be printed on the plurality of papers for providing to the one or more users 101.

Further, at block 303, the method includes scanning, by the MFP 103, each of the plurality of papers comprising one or more user inputs 211 and storing scanned content 213 in a Document Management System (DMS) 105 associated with the MFP 103, wherein the one or more user inputs 211 are provided on the plurality of papers by the users 101, using an erasable ink material. In an implementation, the one or more user inputs 211 may comprise, without limiting to, the handwritten content provided by the one or more users 101 by using the erasable ink material. In an implementation, the erasable ink material may include, without limiting to, the heat erasable ink pen. In an implementation, the scanned content 213 comprises one or more user inputs 211 along with the printed learning aids 209.

Further, at block 305, the method includes erasing, by the MFP 103, the erasable ink on each of the plurality of papers upon storing the scanned content 213 in the DMS 105 for reusing the plurality of papers.

Further, the method 300 includes comparing the scanned content 213 with pre-stored learning aids 215. In an implementation, the pre-stored learning aids 215 may include the content materials which are previously stored in the DMS 105. Further, the method includes separating the user inputs 211 from the scanned content 213 based on the comparison. Furthermore, the method 300 includes storing the user inputs 211 in a DMS 105 profile associated with the unique identifier of the users 101.

Further, the method 300 includes facilitating the one or more users 101 to access the scanned content 213 stored in the DMS 105 upon authentication of the users 101. In an implementation, the one or more users 101 may authenticate to the DMS 105 by using electronic display device to get access to the scanned content 213. As an example, the electronic display device may include, without limitation, a smartphone, a smart tablet, a laptop and/or desktop etc.

Further, the method 300 includes embossing the learning aids 209 with the one or more user inputs 211 for allowing the users 101 to refer the respective one or more user inputs 211 previously by the users 101.

### Exemplary Computer System

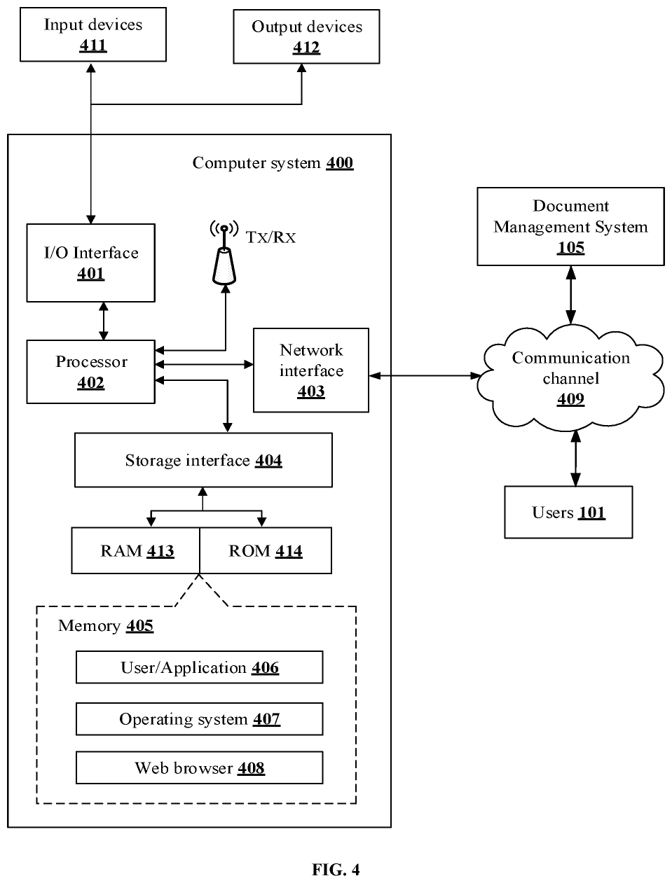

FIG. 4 illustrates a block diagram of an exemplary computer system 400 for implementing embodiments consistent with the present disclosure. In at least one embodiment, the computer system 400 is the Multi-Function Printer (MFP) 103 illustrated in FIG. 1, which may be used for providing reusable learning aids to users 101. The computer system 400 may include a Central Processing Unit (“CPU” or “processor”) 402. The processor 402 may comprise at least one data processor for executing program components for executing user-or-system generated processes. A user may include a student, a teacher, a parent/guardian, or an operator or any system/sub-system being operated parallelly to the computer system 400. The processor 402 may include specialized processing units such as integrated system (bus) controllers, memory management control units, floating point units, graphics processing units, digital signal processing units, etc.

The processor 402 may be disposed in communication with one or more Input/Output (I/O) devices (411 and 412) via I/O interface 401. The I/O interface 401 may employ communication protocols/methods such as, without limitation, audio, analogue, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412.

In at least one embodiment, the processor 402 may be disposed in communication with a communication network 409 via network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring IEEE® 802.11a/b/g/n/x, etc. Using the network interface 403 and the communication network 409, the computer system 400 may receive one or more user inputs 211 from the one or more users 101. Further, the communication network 409 may be used to connect the MFP 101 to the DMS 105.

In an implementation, the communication network 409 may be implemented as one of the several types of networks, such as intranet or Local Area Network (LAN) and such within the organization. The communication network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application interface 406, an operating system 407, a web browser 408, and the like. In some embodiments, computer system 400 may store user/application data 406, such as the data, variables, records, etc. as described in this invention. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2 ®, MICROSOFT® WINDOWS® (XP®, VISTA/7/8, 10 etc.), APPLE® IOS GOOGLE™ ANDROID™, BLACKBERRY® OS, or the like.

The user interface 406 may facilitate display, execution, interaction, manipulation, or operation of program components through textual or graphical facilities. For example, the user interface 406 may provide computer interaction interface elements on a display system operatively connected to the computer system 400, such as cursors, icons, check boxes, menus, scrollers, windows, widgets, and the like. Further, Graphical User Interfaces (GUIs) may be employed, including, without limitation, APPLE® MACINTOSH® operating systems' Aqua °, IBM® OS/2 ®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser 408 may be a hypertext viewing application. Secure web browsing may be provided using Secure Hypertext Transport Protocol (HTTPS), Secure Sockets Layer (SSL), Transport Layer Security (TLS), and the like. The web browsers 408 may utilize facilities such as AJAX, DHTML, ADOBE® FLASH®, JAVASCRIPT®, JAVA®, Application Programming Interfaces (APIs), and the like. Further, the computer system 400 may implement a mail server stored program component. The mail server may utilize facilities such as ASP, ACTIVEX®, ANSI® C++/C #, MICROSOFT®, .NET, CGI SCRIPTS, JAVA®, JAVASCRIPT®, PERL®, PHP, PYTHON®, WEBOBJECTS, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with at least one embodiment. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the Embodiments of the Present Disclosure are Illustrated Herein.

In at least one embodiment, the method of present disclosure proposes erasing the handwritten content on the plurality of papers upon scanning and storing the content in a DMS profile. Consequently, the plurality of papers can be reused for next use and paper wastage is efficiently reduced.

In at least one embodiment, the present disclosure allows the student/teacher/parent to access all the learning content and user notes at any time using any device. Hence, there is no need of physically carrying any gadgets, textbooks or notebooks.

In at least one embodiment, the present disclosure provides an efficient method for improvement of the cognitive skills of the students via use of pen and paper, without necessarily increasing the carbon footprint.

In at least one embodiment, the present disclosure ensures low storage and/or disk space usage as only the user inputs are saved in the DMS by separating the pre-existing learning content from the user inputs.

In light of the technical advancements provided by the proposed method and the update manager, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments need not include the device itself.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based here on. Accordingly, the embodiments are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | Environment |
| 101 | One or more users |
| 103 | Multi-Function Printer (MFP) |
| 105 | Document Management System (DMS) |
| 201 | Processor |
| 203 | I/O interface |
| 205 | Memory |
| 207 | Data |
| 209 | Learning aids |
| 211 | User inputs |
| 213 | Scanned content |
| 215 | Pre-stored learning aids |
| 217 | Other data |
| 219 | Modules |
| 221 | Print module |
| 223 | Scan module |
| 225 | Erase module |
| 227 | Authentication module |
| 229 | Other modules |
| 400 | Computer system |
| 401 | Input/Output interface |
| 402 | Processor |
| 403 | Network interface |
| 404 | Storage interface |
| 405 | Memory |
| 406 | User/Application |
| 407 | Operating system |
| 408 | Web browser |
| 409 | Communication network |
| 411 | Input devices |
| 412 | Output devices |
| 413 | Random Access Memory (RAM) |
| 414 | Read Only Memory (ROM) |

What is claimed is:

1. A method for providing reusable learning aids to users, the method comprising:
printing, by a Multi-Function Printer, MFP, the learning aids on a plurality of papers using an erasable ink, wherein each of the plurality of papers comprise a unique identifier corresponding to the users of the learning aids;
scanning, by the MFP, each of the plurality of papers comprising one or more user inputs, and storing scanned content in a Document Management System, DMS, the DMS associated with the MFP, wherein the one or more user inputs are provided, using an erasable ink material, on the plurality of papers by the users; and
erasing, by the MFP, the erasable ink on each of the plurality of papers upon storing the scanned content in the DMS for reusing the plurality of papers.

2. The method as claimed in claim 1, wherein the unique identifier comprises at least one of a Quick Response (QR) code or a watermark for uniquely identifying the users.

3. The method as claimed in claim 1, wherein the one or more user inputs comprise handwritten content of the one or more users.

4. The method as claimed in claim 1, wherein the erasable ink material is provided by a heat erasable ink pen.

5. The method as claimed in claim 1, further comprising:
comparing the scanned content with prestored learning aids;
separating the user inputs from the scanned content based on the comparing; and
storing the user inputs in a DMS profile associated with the unique identifier of the users.

6. The method as claimed in claim 1, further comprising facilitating the users to access the scanned content stored in the DMS upon authentication of the users.

7. The method as claimed in claim 6, further comprising embossing the learning aids with the one or more user inputs for allowing the users to refer to the respective one or more user inputs previously provided by the users.

8. A Multi-Function Printer, MFP, for providing reusable learning aids to users, the MFP comprising:
a processor; and
a memory, communicatively coupled to the processor, wherein the memory stores processor-executable instructions, which on execution, cause the processor to:
print the learning aids on a plurality of papers using an erasable ink, wherein each of the plurality of papers comprise a unique identifier corresponding to the users of the learning aids;
scan each of the plurality of papers comprising one or more user inputs and storing scanned content in a Document Management System, DMS, the DMS associated with the MFP, wherein the one or more user inputs are provided on the plurality of papers by the users, using an erasable ink material; and
erase the erasable ink on each of the plurality of papers upon storing the scanned content in the DMS for reusing the plurality of papers.

9. The MFP as claimed in claim 8, wherein the unique identifier comprises at least one of a Quick Response (QR) code or a watermark for uniquely identifying the users.

10. The MFP as claimed in claim 8, wherein the one or more user inputs comprise handwritten content of the one or more users.

11. The MFP as claimed in claim 8, wherein the erasable ink material is provided by a heat erasable ink pen.

12. The MFP as claimed in claim 8, wherein the processor is further configured to:
compare the scanned content with prestored learning aids;
separate the user inputs from the scanned content based on the comparing; and
store the user inputs in a DMS profile associated with the unique identifier of the users.

13. The MFP as claimed in claim 8, wherein the processor is configured to facilitate the users to access the scanned content stored in the DMS upon authentication of the users.

14. The MFP as claimed in claim 13, wherein the processor is configured to emboss the learning aids with the one or more user inputs for allowing the users to refer to the respective one or more user inputs previously provided by the users.

15. A non-transitory computer readable medium including instructions stored thereon that when processed by at least one processor, cause a Multi-Function Printer, MFP, to perform operations comprising:
printing the learning aids on a plurality of papers using an erasable ink, wherein each of the plurality of papers comprises a unique identifier corresponding to the users of the learning aids;
scanning each of the plurality of papers comprising one or more user inputs and storing scanned content in a Document Management System, DMS, the DMS associated with the MFP, wherein the one or more user inputs are provided on the plurality of papers by the users, using an erasable ink material; and
erasing the erasable ink on each of the plurality of papers upon storing the scanned content in the DMS for reusing the plurality of papers.

16. The non-transitory computer readable medium as claimed in claim 15, wherein the unique identifier comprises at least one of a Quick Response (QR) code or a watermark for uniquely identifying the users.

17. The non-transitory computer readable medium as claimed in claim 15, wherein the one or more user inputs comprise handwritten content of the one or more users.

18. The non-transitory computer readable medium as claimed in claim 15, wherein the erasable ink material is provided by a heat erasable ink pen.

19. The non-transitory computer readable medium as claimed in claim 15, wherein the processor is further configured to:
compare the scanned content with prestored learning aids;
separate the user inputs from the scanned content based on the comparing; and
store the user inputs in a DMS profile associated with the unique identifier of the users.

20. The non-transitory computer readable medium as claimed in claim 15, wherein the processor is configured to facilitate the users to access the scanned content stored in the DMS upon authentication of the users.

21. The non-transitory computer readable medium as claimed in claim 20, wherein the processor is configured to emboss the learning aids with the one or more user inputs for allowing the users to refer to the respective one or more user inputs previously provided by the users.
